(19) United States
(12) Patent Application Publication
(10) Pub. No.: US 2026/0265032 A1
(43) Pub. Date: Sep. 10, 2026

(54) ORDNANCE HANDLING APPARATUS

(71) Applicant: STRATOM, INC., Louisville, CO (US)

(72) Inventors: Jesse Aaron Weifenbach, Thornton, CO (US); Ryan Joseph Marsini, Frederick, CO (US); David Kevin Regan, Arvada, CO (US); Ryan Matthew Del Gizzi, Arvada, CO (US)

(73) Assignee: STRATOM, INC., Louisville, CO (US)

(21) Appl. No.: 19/561,435

(22) Filed: Mar. 9, 2026

Related U.S. Application Data
(60) Provisional application No. 63/768,557, filed on Mar. 7, 2025.

(51) Int. Cl. B66F 9/075; B66F 9/065; B66F 9/24

(52) U.S. Cl. CPC B66F 9/07568; B66F 9/065; B66F 9/24

(57) ABSTRACT

An ordnance handling apparatus includes a multi-mode steering mechanism with different steering modes, including incremental and absolute steering control, and programmable Ackermann steering. Modular power supply systems include quick-swap battery packs, enabling rapid changeover and hot-swapping of power sources without powering down the vehicle. One or multiple battery packs may be replaced with alternative power modules, which maintain a same form factor for seamless integration. Modular power supply systems include packaging of multiple battery modules that each have an associated charge controller and are not intended to be wired in series, into a single modular pack. The ordnance handling apparatus includes velocity-based traction control versus torque-based traction control, wherein a centerline velocity of the vehicle remains constant when entering a turn by proportionally decreasing the velocity of the inside wheels and proportionally increasing the velocity of the outside wheels based on steering mode and steering angle.

### CROSS-REFERENCE TO RELATED APPLICATIONS

The present application claims the benefit of U.S. Provisional Application No. 63/768,557, filed Mar. 7, 2025, which is hereby specifically incorporated by reference herein in its entirety.

### TECHNICAL FIELD

This disclosure relates generally to material and object handling systems and, more specifically, to a highly maneuverable ordnance handling apparatus with multiple steering modes and an innovative power management system for munitions loading applications.

### BACKGROUND

Ordnance handling apparatuses, such as ordnance loading lift trucks, are specialized vehicles designed for the transportation, loading, and unloading of materials and objects. Such trucks may be used in numerous applications, including military, commercial, and industrial applications, to move and orient relatively heavy items at a desired location. For example, many military applications use munitions loaders for the transportation, loading, and unloading of munitions in military operations. Traditionally, these loaders are robust, heavy-duty machines capable of handling a variety of munitions, including bombs, missiles, and rockets, ensuring they can be efficiently and safely loaded onto aircraft and other delivery systems. Transport of these loaders to forward, unimproved areas presents logistical challenges. Often loaders must be transported upon multiple pallets linked together. These “pallet trains” require specialized loading equipment to move them from staging areas to aircraft or ground transport. Loaders are typically designed for operation on improved surfaces found at aerial ports, making them unsuitable for operation in forward, unimproved areas or incapable of self-loading onto a pallet. These loaders are critical in maintaining the operational tempo of military forces in all environments by enabling quick turnaround times for armed aircraft, thereby enhancing mission readiness and effectiveness.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

The systems, methods, and devices of this disclosure each have several innovative aspects, no single one of which is solely responsible for the desirable attributes disclosed herein.

Various aspects of the present disclosure are directed to an ordnance handling system that provides a range of innovative features designed to enhance the maneuverability, efficiency, transportability, and/or versatility of ordnance handling platforms such as, for example, munitions loading platforms. Various examples of the described systems incorporate a multi-mode four-wheel steering mechanism with multiple different steering and control modes, including incremental and absolute steering control, combined with programmable Ackermann steering geometry and programmable velocity-based traction control.

In such velocity-based traction control, a centerline velocity of the vehicle remains constant when entering a turn by proportionally decreasing the velocity of the inside wheels and proportionally increasing the velocity of the outside wheels based on steering mode and steering angle. This advanced steering and tractive capability allows for precise maneuvering in constrained spaces and unimproved environments, significantly reducing the turning radius, increasing mobility, and improving the overall handling of the vehicle.

Additionally, various aspects of the disclosure provide modular power supply systems enabling rapid changeover and hot-swapping of power sources without the need to power down the vehicle. The battery packs are designed with a quick-latch mechanism for easy attachment and detachment, and incorporate automatic electrical and data connections to simplify user operation. The versatility of the modular power system is further enhanced by the ability to replace one or multiple battery packs with alternative power modules, such as a diesel generator, or a tethered AC to DC converter, each of which maintain a same form factor for seamless integration.

Further, various aspects of the disclosure provide modular power supply systems that provide packaging of multiple battery modules that each have an associated charge controller and are not intended to be wired in series, into a single modular pack. In some aspects, each of the battery modules may be separately controlled with a group controller that monitors a charge state and voltage level associated with each battery module, and couples different combinations of battery modules with a power bus to manage potential different charge and voltage levels of different battery modules.

In further aspects, a smart modular tool head is provided, in which multiple different material handling tools may be coupled with a quick change tool plate that is mounted at an end of a lift arm of the system. In some aspects, the different tools may include a lift table that is rotatable/tiltable to provide precise movement of an item, a gripper that is controllable to grip and hold items, and the like. In some aspects, the quick change tool plate may include a quick release/connect tool changer. Additionally, or alternatively, the quick change tool plate may include one or more of a data ports (e.g., a CANbus data connection port), power connection (e.g., an AC or DC power port), or hydraulic connections, which may enable hands free tool changing and smart controls of accessories (e.g., encoders/sensors). In some aspects, one or more operational parameters may be adjusted based on a type of tool that is coupled with the quick change tool plate. For example, encoder values related to a position of the tool may be adjusted based on the type of tool, which may be detected based on a tool identification obtained via the data port of the quick change tool place. Additionally, or alternatively, one or more pressures or flow rates associated with hydraulic or hydrostatic actuators may be adjusted based on the type of tool that is coupled with the quick change tool plate.

In still further aspects, the ordnance handling system may be configured for efficient transport between different locations. For example, the ordnance handling system may have a length and width that corresponds to a length and width of a standard pallet size and enables the ordnance handling to be transported on such a standard pallet (e.g., a single 463L pallet). In some aspects, the ordnance handling system may include a flip-up lift table, where the lift table (i) in a down position is located in front of the front wheels of the ordnance handling, and (ii) in an up position is located at or behind a front-most portion of the front wheels. Further, in some aspects, the ordnance handling apparatus may drive itself onto a pallet such that it can be loaded on the pallet without assistance of an auxiliary material handling unit. Additionally, the ordnance handling apparatus may have an austere drive train to provide reliable movement in austere (e.g., unimproved) environments, such as with larger wheels and off-road traction control capability. In some aspects, the ordnance handling apparatus may include velocity-based traction control versus torque-based traction control, wherein the centerline velocity of the vehicle remains constant when entering a turn by proportionally decreasing the velocity of the inside wheels and proportionally increasing the velocity of the outside wheels based on steering mode and steering angle.

This innovative combination of advanced steering control and a flexible power supply system makes the disclosed system well suited for a variety of applications, including commercial, industrial, or military applications. For example, the ability to quickly adapt to different power sources and the precise maneuverability offered by the multi-mode steering provide significant operational advantages, making described systems a valuable asset in munitions handling and other logistical operations.

Disclosed is an ordnance handling apparatus comprising a pair of front steering assemblies each coupled with a corresponding front wheel to provide independently steerable front wheels, wherein the pair of front steering assemblies and associated front wheels are mechanically separated to allow a lift table of the ordnance handling apparatus to be positioned between the pair of front steering assemblies at an elevation above or below a mid-point of the front steering assemblies; a rear axle assembly having independently steerable rear wheels; a plurality of steering actuators operatively connected to the front wheels and the rear wheels; and a controller configured to selectively operate the ordnance handling apparatus in a selected steering mode of multiple selectable steering modes.

Also disclosed is a modular power supply apparatus for a vehicle, the modular power supply apparatus comprising a vehicle chassis that includes an electrical system, a control system, and a propulsion system; and two or more power supply packs mountable on the vehicle and configured to provide operating power to the electrical system, each power supply pack of the two or more power supply packs comprising: a quick-latch mechanism configured to engage with a securement assembly on the vehicle chassis and couple a power port associated with the power supply pack with a corresponding vehicle power port that is connected to the electrical system; and a transport mechanism configured to provide for movement of the power supply pack toward and away from the vehicle chassis, wherein a first power supply pack is configured to be disengaged from the vehicle chassis and electrical system while a second power supply pack is providing operating power to the electrical system, and a third power supply pack is configured to be engaged with the vehicle chassis and electrical system while the second power supply pack is providing operating power to the electrical system, and the control system initiates use of operating power from the third power supply pack responsive to the third power supply pack being engaged with the electrical system.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The features and components of the following figures are illustrated to emphasize the general principles of the present disclosure. The drawings are not necessarily drawn to scale. Corresponding features and components throughout the figures may be designated by matching reference characters for the sake of consistency and clarity.

FIGS. 1 and 1A show diagrams of an example lift truck in accordance with various aspects of the present disclosure.

FIG. 2 shows a diagram of example front and rear steering assemblies of a lift truck in accordance with various aspects of the present disclosure.

FIG. 3 shows a diagram of example front steering assembly of a lift truck in accordance with various aspects of the present disclosure.

FIGS. 4, 5, 6, and 7 show diagrams of an example rear steering assembly of a lift truck in accordance with various aspects of the present disclosure.

FIGS. 8, 9, 10, 11, 12, 13, 14, and 15 show diagrams of example steering modes of a lift truck in accordance with various aspects of the present disclosure.

FIGS. 16, 17, 18, and 19 show diagrams of an example modular power source of a lift truck in accordance with various aspects of the present disclosure.

FIG. 20 shows a diagram of an example power architecture of a lift truck in accordance with various aspects of the present disclosure.

FIGS. 21, 22, and 23 show diagrams of example modular power source types of a lift truck in accordance with various aspects of the present disclosure.

FIG. 24 shows an example flow chart of operation for a battery pack that includes multiple battery modules in accordance with various aspects of the present disclosure.

Like reference numbers and designations in the various drawings indicate like elements.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The following description is directed to some particular examples for the purposes of describing innovative aspects of this disclosure. However, a person having ordinary skill in the art will readily recognize that the teachings herein can be applied in a multitude of different ways. For example, various examples are discussed wherein with respect to loading of munitions in a military-based application, and it will be readily recognized that numerous other use cases for ordnance handling apparatuses and related systems discussed herein.

The present disclosure recognizes that current ordnance handling apparatuses, including lift trucks, such as munitions loaders, have provided reliable service for a long time, but some of the designs use relatively old technology and have several notable shortcomings. For example, existing lift truck maneuverability is often limited, especially in constrained or cluttered environments such as flight decks or storage facilities. Further, these settings require precise and agile movements for heavy objects in close proximity to very valuable equipment (e.g., aircraft), and traditional loaders struggle to achieve efficient movement and munitions loading due to their size and steering mechanisms. These limitations can lead to operational delays and increased risk of accidents, impacting overall mission efficiency and safety. Additionally, many existing loaders are reliant on technology and designs that do not incorporate modern advancements in automation and control systems. This includes limitations in steering modes and the inability to perform complex maneuvers, such as in some vehicles that provide steering only at rear wheels thereof, which may hamper their operational flexibility and precision. Traditional loaders have further been limited in their loading capacity. A lift vehicle with multiple different steering modes as discussed herein provides a substantial benefit over such traditional vehicles, allowing for more precise and efficient maneuvering, as well as increased load capacity (e.g., up to or greater than about 4,000 lbs.).

For example, traditional munition loader platforms, such as the MJ-1 “Jammer” and MHU-83 have been workhorses in military operations for decades, primarily utilizing hydraulic lifting mechanisms and diesel power plants. These vehicles are designed to handle a wide range of munitions, from small guided bombs to large cruise missiles, with precise control for final positioning and mating with aircraft hardpoints. The majority of current platforms require significant manual operation and have limited maneuverability, often necessitating multiple positioning attempts to achieve proper alignment with aircraft. This problem is compounded by newer generation aircraft that often sit lower to the ground and/or have an increased number of interference points compared to older aircraft. As discussed, such manual operation can lead to operational delays and hamper overall mission efficiency and safety.

Furthermore, the current power systems of ordnance handling apparatuses can be cumbersome and inefficient. For example, traditional lift trucks often rely solely on older, mechanically injected diesel engines, which can be louder, less efficient, and limit operating locations compared to modem hybrid or fully electric systems. The reliance on a single power source also complicates logistics, as fueling and servicing these engines require additional resources and time. Further, diesel, other internal combustion engines, produce exhaust that can limit operation in indoor or enclosed environments. The introduction of quick-swap or hot-swap battery systems, as discussed herein, demonstrates a significant improvement in power systems, offering modular power sources and reduced downtime during operations. These advancements address critical gaps in the existing technology and present a pathway to more efficient and effective munitions handling.

In accordance with various aspects discussed herein, an ordnance handling apparatus is provided. The ordnance handling can be provided in the form of a lift truck, for example and without limitation, such as an ordnance loader vehicle (which may also be referred to as a Munitions Handling Unit (MHU) or bomb lifts), that is designed to safely transport and load munitions onto military aircraft. For example, lift trucks as discussed herein may provide more advanced loader vehicles with enhanced capabilities including electronic control systems, electric/hybrid propulsion systems, improved maneuverability, and alternative power sources. Such systems may reduce the physical burden on operators while increasing efficiency through features like multi-mode steering, operator control from the front or rear of the loader (e.g., with associated lockout of control or specific control features from other locations), automated positioning assistance, and electric powertrains. Such vehicles may provide efficient operations in confined or sensitive spaces like hangars and ammunition storage areas, maintaining precise control during final munition positioning, and ensuring reliable operation in various environmental conditions and mission scenarios, including in austere or unimproved terrain. It is noted that while various examples discussed herein are directed to military applications, lift vehicles and techniques discussed herein may be used in numerous settings in addition to military applications, such as industrial settings, manufacturing settings, commercial settings, warehouse settings, among others, for example.

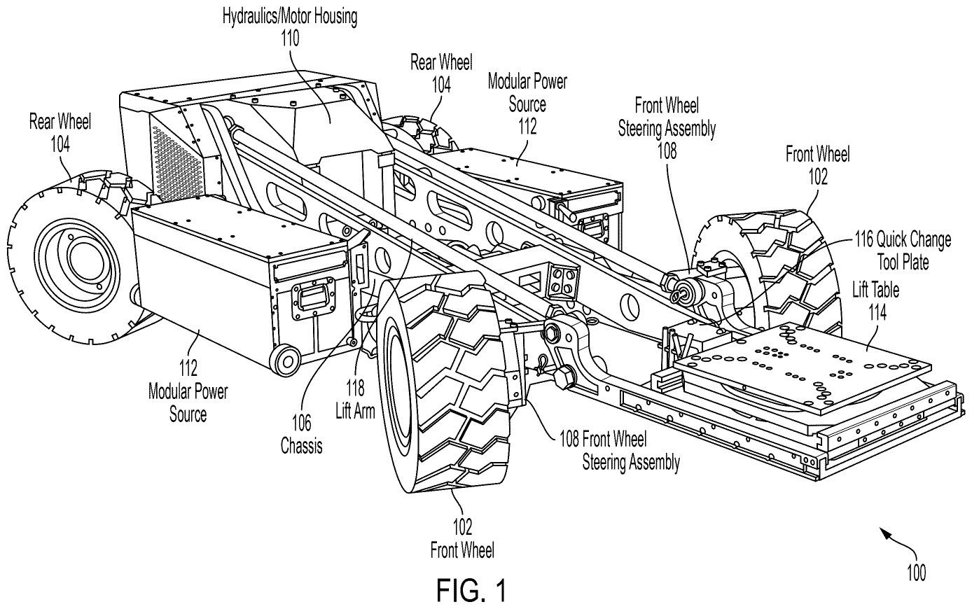

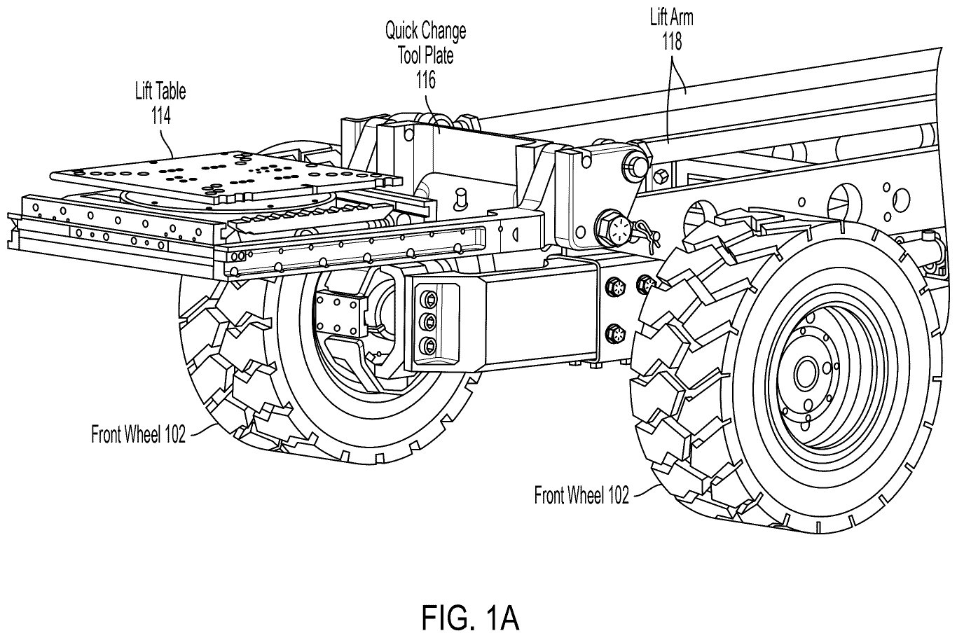

FIG. 1 shows a diagram of an example ordnance handling apparatus 100, which can be a lift truck 100 for example and without limitation, in accordance with various aspects of the present disclosure. In other aspects, the ordnance handling apparatus 100 can be any other suitable vehicle or piece of equipment for handling and/or loading ordnance. Ordnance can include a variety of munitions, including, for example and without limitation, bombs, missiles, rockets, gun ammunition, and the like. The lift truck 100 can include front wheels 102 and rear wheels 104 mounted to a chassis 106. The lift truck 100 may implement four-wheel steering in which both the front wheels 102 and rear wheels 104 are steerable.

The front wheels 102 may have associated front wheel steering assemblies 108, which may not be coupled with each other and thereby allow independent steering of the front wheels. Likewise, the rear wheels 104 can also be steerable independently of the front wheels 102. The lift truck 100 may also include a hydraulics and motor housing 110, and may be powered by one or multiple modular power sources 112. In some aspects, an electric propulsion system may be used to power the front wheels 102 and the rear wheels 104. In other aspects, any or all of the front wheels 102 and/or rear wheels 104 can be replaced with continuous tracks, such as caterpillar treads, for example and without limitation.

A lift table 114 may be mounted to a lift arm and may be used to support a load that is to be lifted, dropped, or otherwise moved. In some aspects, the lift table 114 may be tiltable and may include a turntable. In some aspects, the lift table 114 may include one or more connection points for mounting a carrier that is associated with a load that is to be transported.

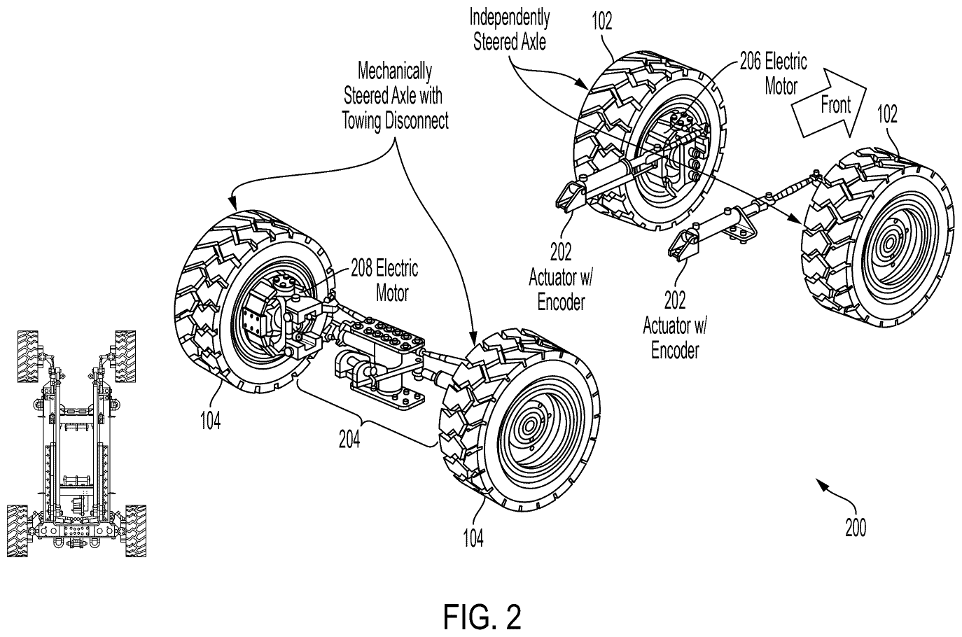

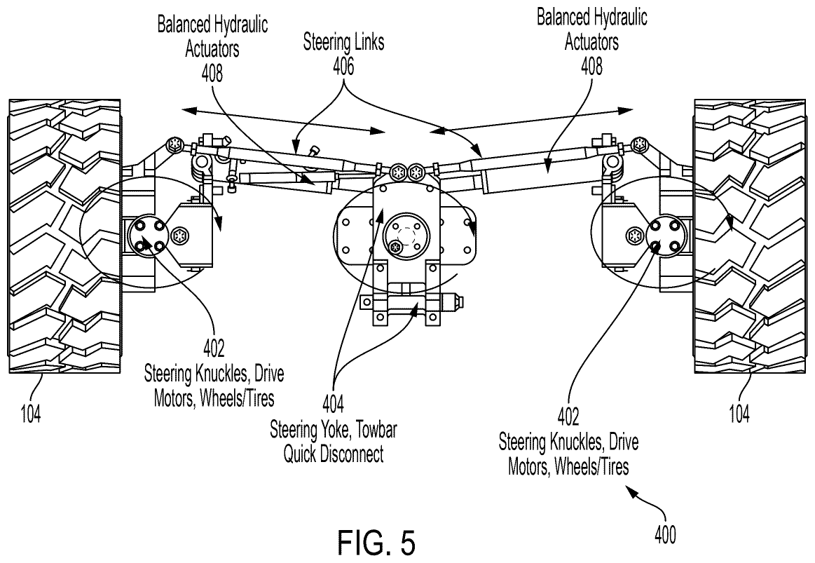

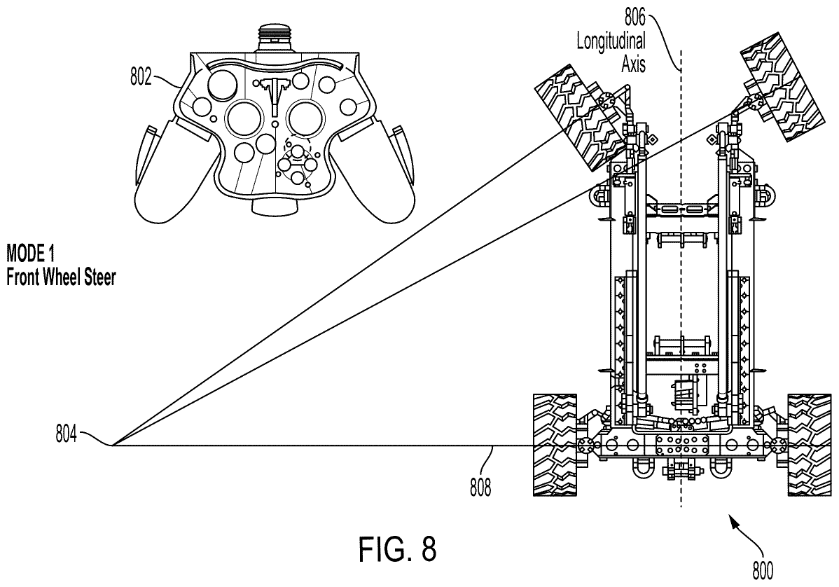

As discussed, the lift truck 100 may use four wheel steering to enhance maneuverability. In some aspects, the lift truck 100 may include a multi-mode steering system with five distinct operational modes, including front wheel steering, rear wheel steering, coordinated four-wheel steering, crab steering, and differential steering. The multi-mode steering system may provide programmable Ackermann steering, where steering angles for one or more wheels may be based on the selected steering mode, a speed of the vehicle, or any combination thereof. FIGS. 2 through 7 show examples of aspects of the wheel and steering systems, and FIGS. 8 through 15 show examples of different steering modes.

In some aspects, an electric system may be implemented, in which an electric motor is coupled with a mechanical safety brake and a geared wheel hub to multiple the motor's torque output, providing increased driving force and allowing the motor to be place in an optimal operating condition, resulting in enhanced energy efficiency.

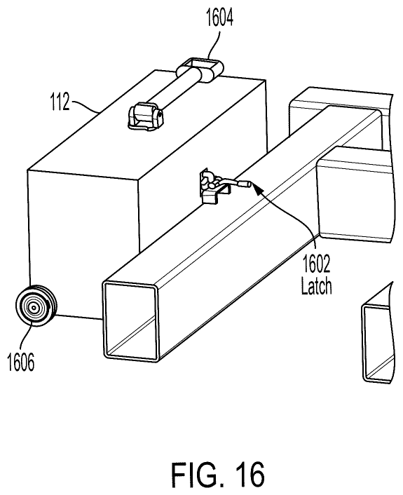

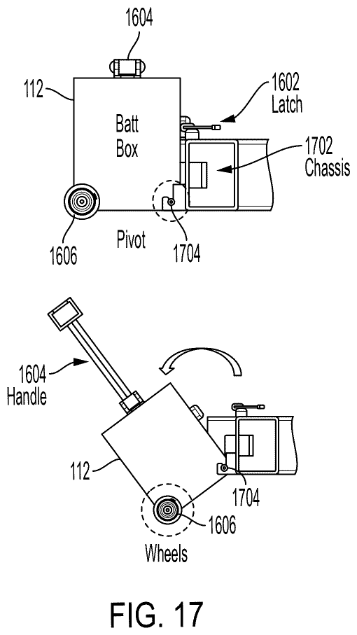

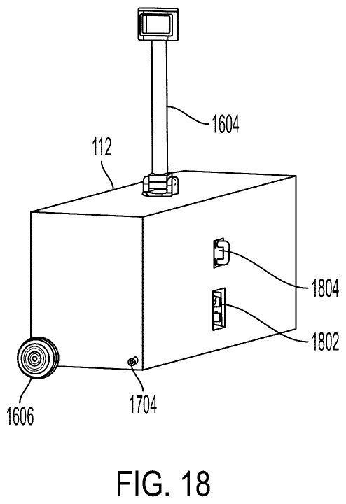

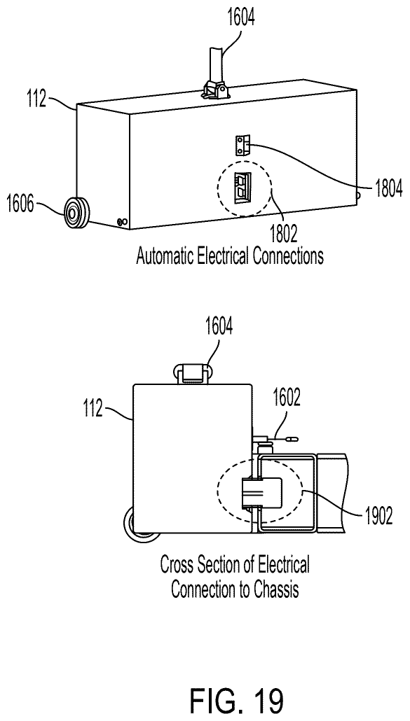

In some aspects, the multiple modular power sources 112 may provide a hot-swappable battery system with quick-detach and hot-swappable power packs with integrated transport features, and may provide modular power source capability supporting battery, diesel generator, or AC shore power. In some aspects, a power control system may provide automatic voltage monitoring and switching, and integrated charge equalization. FIGS. 16 through 23 show examples of aspects of the modular power system. In some aspects, a modular battery pack may include multiple off-the-shelf battery modules that each have a charge control system, which may be connected in series to provide a higher operating voltage, and which may be charged and discharged in accordance with a system charge controller that coordinates each of the individual charge controllers and selects which of the battery modules are to be coupled with a power bus.

In further aspects, a smart modular tool head can be provided, as illustrated in FIGS. 1 and 1A, in which multiple different tools may be coupled with a quick change tool plate 116 of a lift arm 118 of the lift truck 100. In some aspects, the different tools may include a lift table 114, as illustrated in FIGS. 1 and 1A, which may be rotatable and tiltable to provide precise movement of an item (e.g., munition) located on the lift table.

114. In other examples, tools that may be coupled with the quick change tool plate 116 may include, but are not limited to, a gripper that is controllable to grip and hold items, a bucket, a fork, a pintle hook, a carrying basket, a blade, a moldboard, a power tool (e.g., a drill or a jackhammer, for example), an aerial lift platform or basket for elevating a worker (e.g., for performing maintenance of an aircraft), and the like. In some aspects, such as aspects wherein the jackhammer can be coupled to the tool plate 116, the lift arm 118 can comprise the ability to press the tool downward against a surface, such as a ground surface for example. In some aspects, the quick change tool plate 116 may include a quick release/connect tool changer. Additionally, or alternatively, the quick change tool plate 116 may include one or more of a data port, such as a CAN bus data connection port, a power connection, such as an AC or DC power port, or hydraulic connections, which may enable hands free tool changing and smart controls of accessories (e.g., using encoders/sensors). In some examples, different tools may include an identifier (e.g., an optical or electronic identifier) that may be read by the quick change tool plate, which may provide an indication of the identified tool identification to the controller via the data port.

In still further aspects, the lift truck 100 may be configured for efficient transport between different locations. For example, the lift truck 100 may have a total length and width that corresponds to a length and width of a single 463L pallet (or that corresponds to some other standard pallet size) and enables the lift truck 100 to be transported on such a standard pallet. For example, the lift truck 100 may include a flip-up lift table 114 wherein, in the down position, such as illustrated in FIG. 1, the flip-up lift table 114 can be located in front of the front wheels 102 of the lift truck 100, and in an up position, the flip-up lift table 114 can be tilted upward (or downward with the lift arm 118 raised) and can be located at or behind a front-most portion of the front wheels 102. Further, in some aspects, the lift truck 100 may drive itself onto a pallet such that it can be loaded on the pallet without assistance of an auxiliary material handling unit, which may enhance operational flexibility in remote locations. Additionally, the lift truck 100 may have an austere drive train to provide reliable movement in austere (e.g., unimproved) environments, such as with larger wheels and off-road traction control capability. In some aspects, the lift truck 100 may include velocity-based traction control versus torque-based traction control, wherein a centerline velocity of the vehicle remains constant when entering a turn by proportionally decreasing the velocity of the inside wheels and proportionally increasing the velocity of the outside wheels based on steering mode and steering angle. This method allows operation without tire slippage or scrub in all operating conditions and steer angles. In addition to reducing tire scrub and slippage during a turn, velocity-based traction control can monitor and compare individual wheel speeds and compare against expected vehicle speed to identify excessive wheel spin. In a degraded traction scenario, individual wheel speeds can be reduced or varied in order to regain traction.

The lift truck 100 as discussed herein thus may provide multiple benefits and operational efficiencies. For example, maneuverability may be enhanced through selection of a suitable steering mode, and programmable Ackermann steering geometry for determination of an optimal vehicle turning radius. The steering may also provide both incremental and absolute steering control methods (e.g., based on speed). Additionally, in some aspects, a mechanical tow and steer disconnect capability may facilitate towing of the lift truck 100, and the lift truck 100 dimensions and operation may allow for transport on a standard size pallet. Further, the lift truck 100 may provide flexibility for selection and use of different tools, with efficient tool change capability.

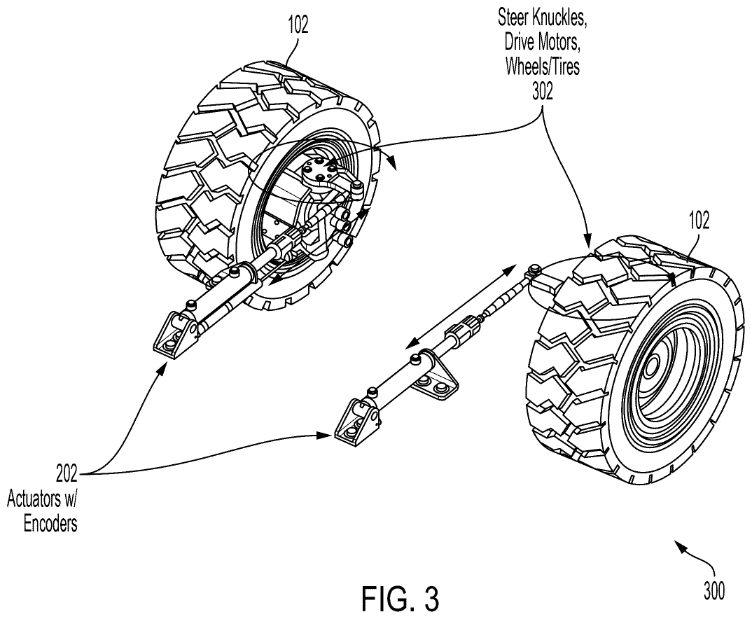

FIGS. 2 through 7 show examples of aspects of the wheel and steering systems for such an ordnance handling apparatus 100. More specifically, FIG. 2 shows a diagram of example front and rear steering assemblies 200 of a lift truck (which may be similar to the lift truck 100 shown in FIGS. 1 and 1A) in accordance with various aspects of the present disclosure. In this example, each of the front wheels 102 may be coupled with an electric motor 206 and an actuator with encoder 202 may be coupled with a steering knuckle to provide independent steering of each of the front wheels 102. Further, each of the rear wheels 104 may have an associated electric motor 208, and be coupled with a rear axle assembly 204 which may be a mechanically steered axle with towing disconnect. FIG. 3 shows a diagram of example front steering assembly 300 of a lift truck in accordance with various aspects of the present disclosure. In this example, each of the front wheels 102 maybe coupled with an associated steer knuckle and drive motor 302, and may be independently steerable using hydraulic actuators with encoders 202.

In example aspects, each of the front wheels 102 and rear wheels 104 can be independently driven by their corresponding motor, which can provide each wheel 102,104 with independent torque control and improved traction control. The speed and the steering angle of each of the front wheels 102 and rear wheels 104 can thereby be independently controlled. The speed and steering angle of each wheel 102,104 can be dynamically calculated based on the commanded centerline velocity of the lift truck, so that the actual velocity of the lift truck can be maintained at the commanded velocity throughout various steering maneuvers, as described in further detail below, wherein the centerline velocity of the vehicle remains constant when entering a turn by proportionally decreasing the velocity of the inside wheels and proportionally increasing the velocity of the outside wheels based on steering mode and steering angle. Independently controlling each of the wheels 102,104 to maintain the velocity of the lift truck can prevent or eliminate scrubbing and skidding of wheels 102,104. Such advanced steering capability can allow for precise maneuvering of the lift truck, which can be particularly beneficial in constrained spaces, in close proximity to valuable equipment, and when precise positioning is required for loading/unloading ordnance.

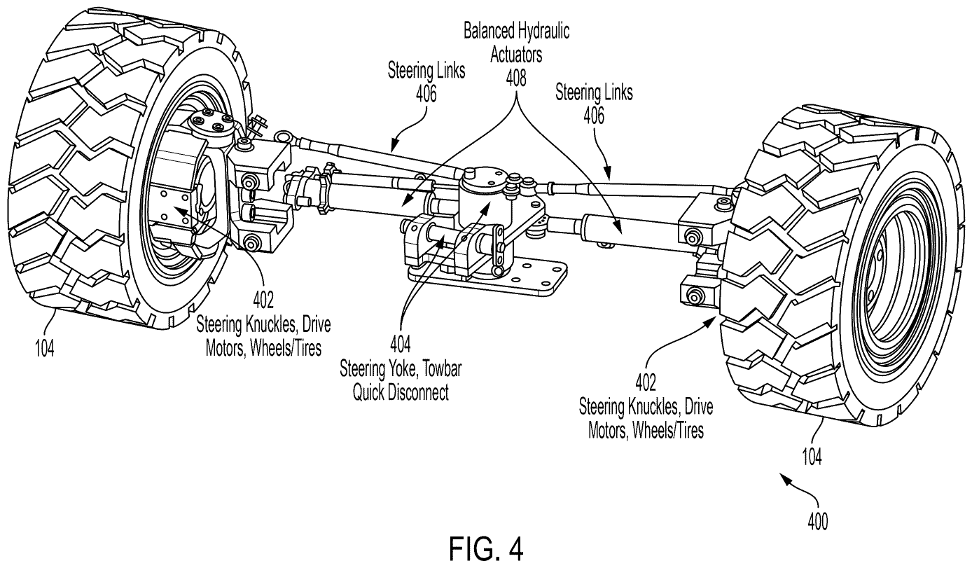

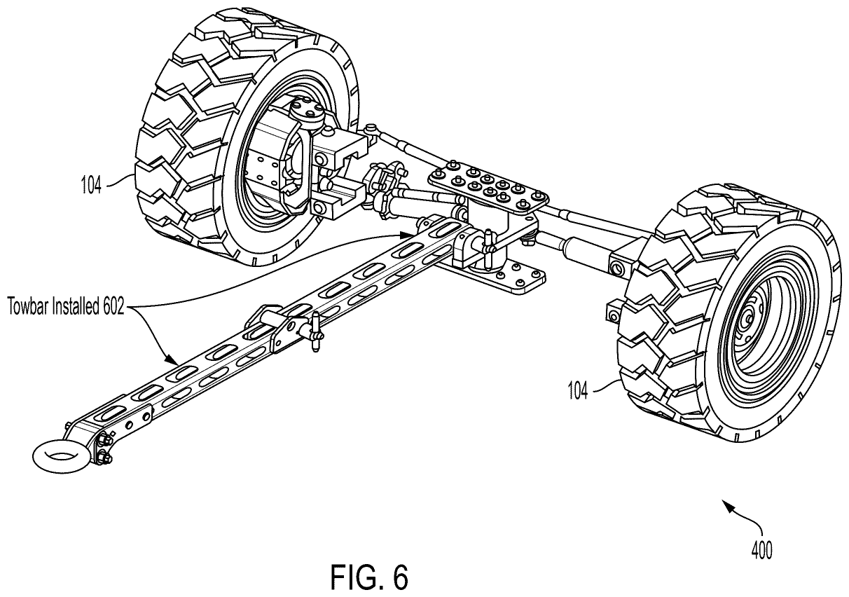

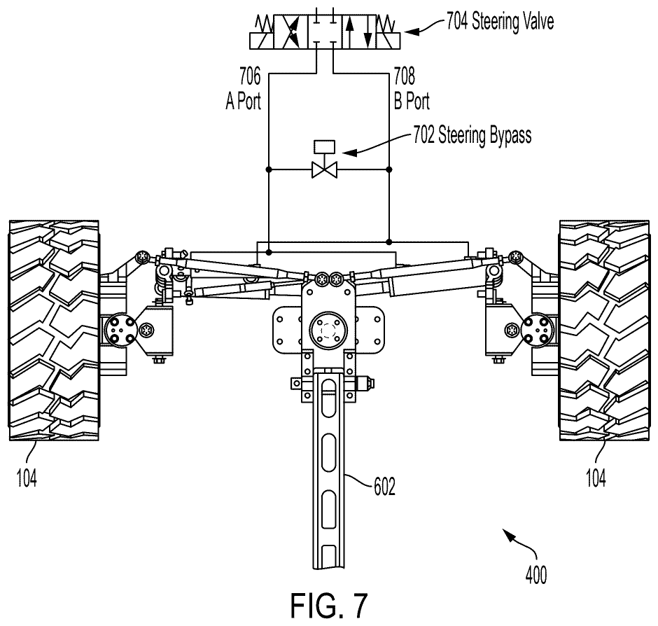

FIGS. 4 through 7 show diagrams of an example rear axle and steering assembly 400 of a lift truck (which may be similar to the lift truck 100 shown in FIGS. 1 and 1A) in accordance with various aspects of the present disclosure. Each rear wheel 104 may have an associated steering knuckle and drive motor 402. Steering of the rear wheels 104 may be performed using steering links 406 and hydraulic actuators 408. In some aspects, the hydraulic actuators 408 may be balanced hydraulic actuators 408 and associated with an encoder that can indicate a steering state of the rear wheels 104. In such aspects, a steering yoke and tow bar quick disconnect 404 may be used to tow the lift truck, and a steering controller may obtain the state of the rear wheels 104 from the encoder for subsequent operations after towing of the lift truck is completed. FIG. 6 illustrates a tow bar 602 coupled with a rear axle. FIG. 7 shows hydraulic connections that include a steering valve 704, an A port 706 and a B port 708 that can be used to actuate hydraulic actuators 408 and steer the rear wheels 104. A steering bypass 702 may be used when the lift truck is being towed to allow the tow bar 602 to steer the rear wheels 104 based on a direction of the tow bar 602 in relation to a longitudinal axis of the lift truck.

FIGS. 8 through 15 show diagrams of example steering modes of a lift truck (which may be similar to the lift truck 100 shown in FIGS. 1 and 1A) in accordance with various aspects of the present disclosure. As discussed, a lift truck in accordance with various aspects may have multiple steering modes, including a front wheel steer mode 800 as shown in FIG. 8. In this example, an operator interface 802 may allow a user may use to select a steering mode. The operator interface 802 may be a tethered controller, or may be a wireless controller, that provides input to a control system of the lift truck to control speed, steering, and/or lift table operations. In cases where the front wheel steer mode 800 is selected, the front wheels of the lift truck may turn relative to a longitudinal axis 806 of the lift truck. In some aspects, a steering angle of the front wheels may be determined based on the selection of the front wheel steer mode 800 and a point 804 associated with a transverse axis 808 that corresponds to the rear axle of the lift truck. In some aspects, the steering angle of the front wheels may be determined in accordance Ackermann geometry principles, as will be discussed in more detail below.

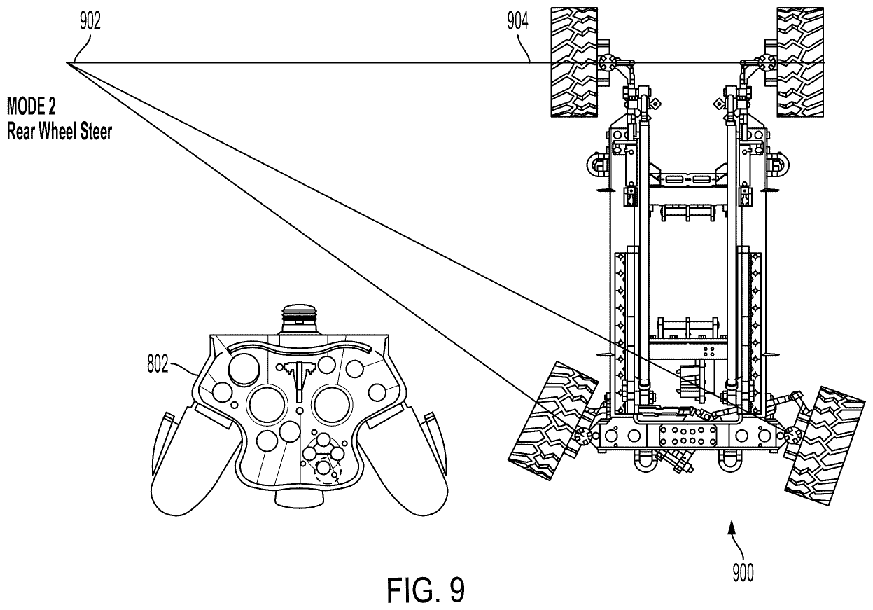

A rear wheel steer mode 900 is shown in FIG. 9. In this example, a user may use the operator interface 802 to select the rear wheel steer mode, in which the front wheels can remain fixed in a “straight” position (e.g., a longitudinal axis of each front wheel can be substantially parallel with a longitudinal axis of the lift truck). In cases where the rear wheel steer mode 900 is selected, the rear wheels of the lift truck may turn relative to the longitudinal axis of the lift truck. In some aspects, a steering angle of the rear wheels may be determined based on the selection of the rear wheel steer mode 900 and a point 902 associated with a transverse axis 904 that corresponds to a front axle of the lift truck. In some aspects, the steering angle of the rear wheels in this mode may be determined in accordance Ackermann geometry principles, as will be discussed in more detail below.

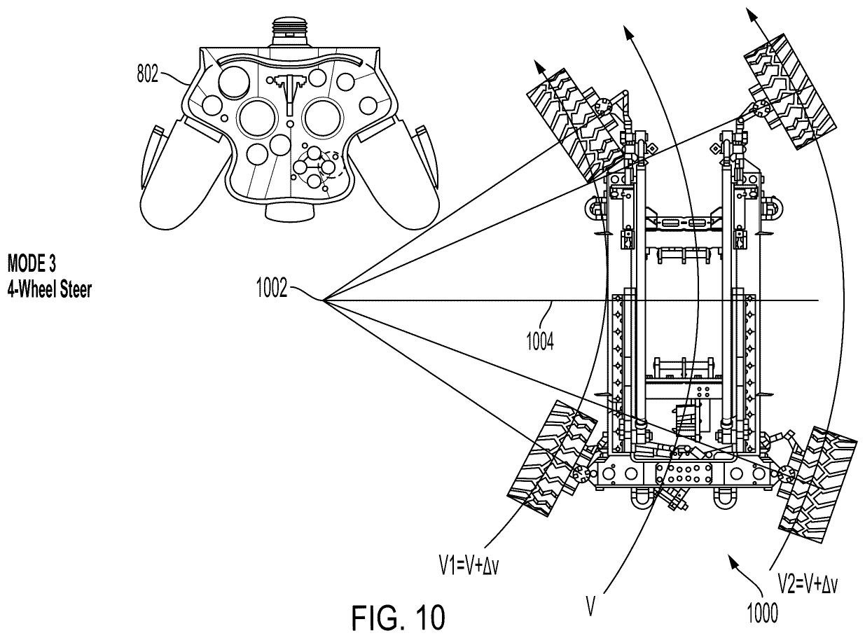

A four-wheel steer mode 1000 is shown in FIG. 10. In this example, a user may use the operator interface 802 to select the four-wheel steer mode, in which the front wheels and the rear wheels of the lift truck may turn relative to the longitudinal axis of the lift truck. In some aspects, a steering angle of both the front wheels and the rear wheels may be determined based on the selection of the rear wheel steer mode 900 and a point 1002 associated with a transverse axis 1004 that corresponds to a midpoint of the lift truck. In some aspects, the steering angles of the front wheels and the rear wheels in this mode may be determined in accordance Ackermann geometry principles, as will be discussed in more detail below.

As previously described, in some example aspects, the lift truck may include velocity-based traction control versus torque-based traction control. As shown in FIG. 10, in such velocity-based traction control, the centerline velocity V of the vehicle can remain constant when entering a turn by proportionally decreasing the velocity V1 of the inside wheels and proportionally increasing the velocity V2 of the outside wheels based on steering mode and steering angle. In addition to velocity-based traction control reducing tire scrub and slippage during a turn, velocity-based traction control can monitor and compare individual wheel speeds and compare against expected vehicle speed to identify excessive wheel spin. In a degraded traction scenario, individual wheel speeds can be reduced or varied in order to regain traction.

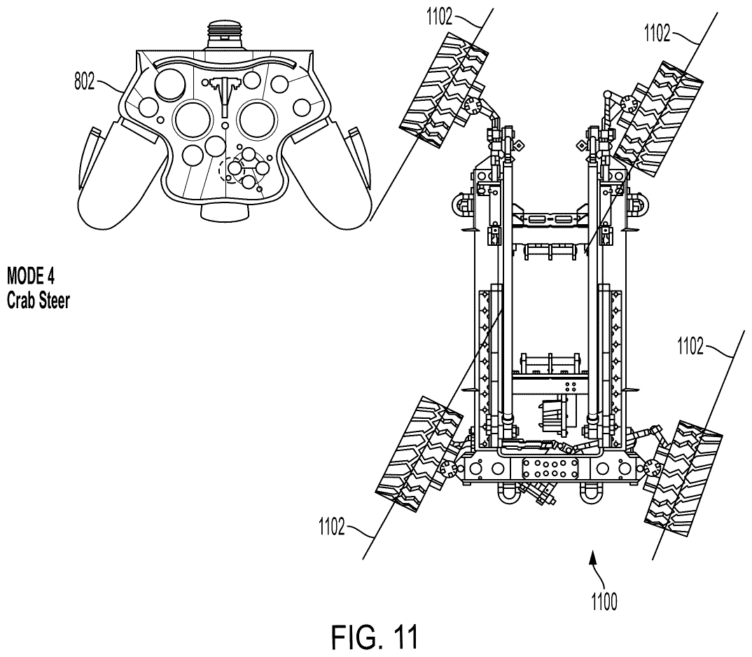

A crab steer mode 1100 is shown in FIG. 11. In this example, a user may use the operator interface 802 to select the crab steer mode, in which the front wheels and the rear wheels of the lift truck may turn at a same angle relative to the longitudinal axis of the lift truck. In some aspects, a steering angle of both the front wheels and the rear wheels may be determined based on the selection of the crab steer mode 1100 and a wheel longitudinal axis 1102 that is non-parallel with the longitudinal axis of the lift truck. In the crab steer mode 1100, no Ackermann compensation is typically needed as all wheels follow parallel paths.

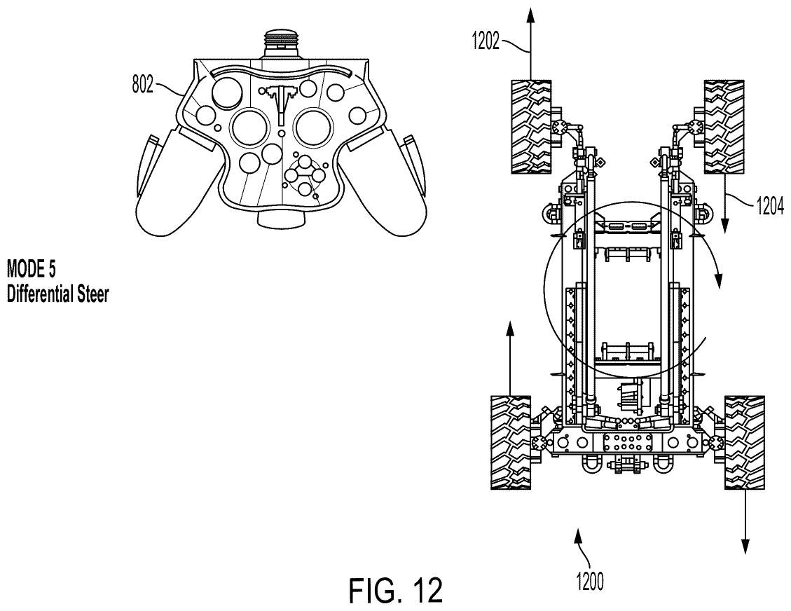

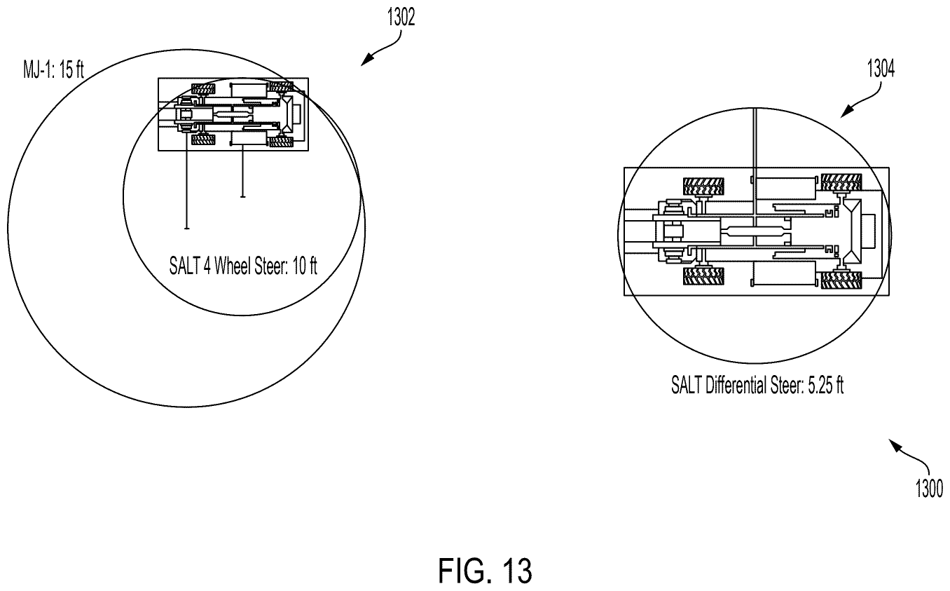

A differential steer mode 1200 is shown in FIG. 12. In this example, a user may use the operator interface 802 to select the differential steer mode, in which all wheels can be maintained in a fixed straight direction relative to the longitudinal axis of the lift truck, and the wheels on one side of the lift truck can move in a first direction 1202 and the wheels on the opposite side of the lift truck can move in a second direction 1204 (e.g. opposite of the first direction), to cause the lift truck to rotate about a midpoint between the front and rear wheels. In the differential steer mode 1200, no Ackermann compensation is typically needed as all wheels remain at a fixed angle. FIG. 13 shows examples 1300 of a turning radius of the lift truck with four wheel steer 1302 (e.g., with a turning radius of 10 feet, which is less than a traditional MJ-1 turning radius of about 15 feet), and with differential steer 1304 (e.g., with a turning radius of 5.25 feet).

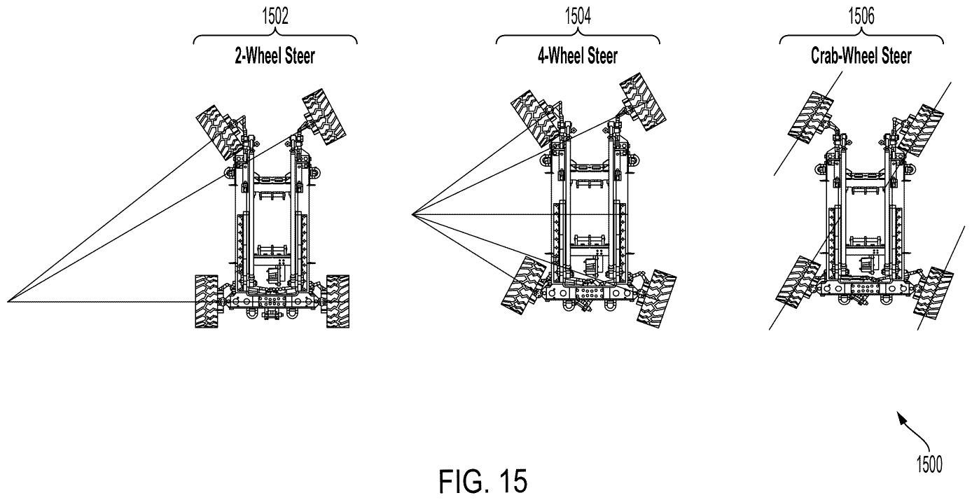

In some further aspects, one or more alternative or additional steering modes may be available, such as a carousel steering mode in which, for example, each front wheel can be independently steered to point toward a center of the front of the lift truck and each rear wheel can be independently steered to point toward a center of the rear of the lift truck, and wheels on opposite sides of the lift truck are rotated in opposite directions. As such, a turning point can be moved along a longitudinal centerline of the lift truck to cause the vehicle to rotate about a programmable point in space. For example and without limitation, the lift truck could be programmed to turn about a point that corresponds to a center of the lift table 114 and/or the munition being loaded thereon. Such a mode may provide reduced tire slip compared to the differential steer mode. FIG. 15 shows examples 1500 of two wheel steer 1502, four-wheel steer 1504, and crab steer 1506, and associated wheel angles.

As discussed, in some aspects Ackermann steering geometry may be calculated based on a steering mode of the vehicle. For example, for the front wheel steer mode, the front wheels may follow Ackermann geometry principles while the rear wheels remain fixed forward. This mode is typically used for conventional driving operations and provides familiar handling characteristics for operators accustomed to standard vehicles. The rear-wheel steer mode may provide that the front wheels remain fixed forward while the rear wheels provide directional control. This configuration is particularly useful when precise backing maneuvers are required, giving operators enhanced control when positioning the vehicle in tight spaces or approaching aircraft loading positions. The rear steering capability is complemented by the described mechanical tow disconnect feature that allows the vehicle to be safely towed when needed. The four-wheel steer mode provides that both front and rear wheels actively participate in turning maneuvers. In this mode, the front and rear wheels can steer in opposite directions, significantly reducing the vehicle's turning radius while maintaining stability. This mode is especially valuable when maneuvering in confined spaces such as ammunition storage areas or crowded hangars. The crab steer mode provides that all four wheels can turn in the same direction and at the same angle. This allows the vehicle to move laterally while maintaining its orientation, which may be beneficial for precise positioning during munitions loading operations. For example, crab steering may provide operators with the ability to make fine adjustments to the vehicle's position without requiring multiple forward and reverse movements. The differential steer mode may achieve the vehicle's minimum turning radius (e.g., 5.25 feet). This mode utilizes independent wheel speed control to enable extremely tight turning maneuvers, effectively allowing the vehicle to pivot around its center point.

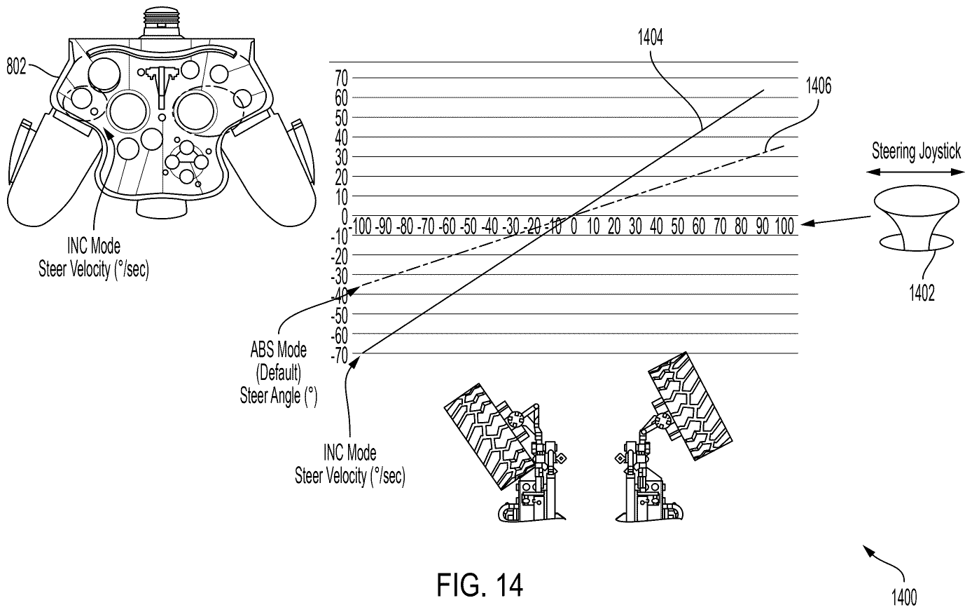

In some aspects, the lift truck can be operated in either incremental or absolute steering control modes, such as illustrated in FIG. 14. The incremental control mode 1406 may provide continuous adjustment of steering angle based on operator input (e.g., at a joystick 1402 of operator interface 802) and may allow for intuitive control during dynamic operations, where the operator can gradually adjust the steering angle based on real-time feedback and operational requirements. The absolute control mode 1404 may allow direct command of specific wheel angles for precise positioning, and enable continuous and smooth adjustment of wheel positions. In absolute control mode, the system can allow for direct command of specific wheel angles, enabling precise positioning and repeatable maneuvers. This mode may be beneficial when exact wheel positions are desired for specific operations or when transitioning between different steering modes. Rather than controlling the rate of change, absolute steering can allow operators to command specific angular positions for each wheel, ensuring accurate and consistent vehicle positioning. The combination of these two control methodologies provides operators with flexibility in how they control the vehicle based on specific task requirements. Incremental steering offers natural, fluid control for general maneuvering and dynamic operations, while absolute steering provides the precision and repeatability needed for specific positioning tasks. The system can seamlessly transition between these control modes, allowing operators to select the most appropriate method for their current operational needs.

In some aspects, steering control may be based on an actuator system with steering actuators coupled with each wheel, with position feedback capability to maintain commanded angles. The actuators may integrate with a controller area network (CAN) bus control architecture of the vehicle to receive commands and provide position feedback, enabling coordinated movement across all steering modes. As discussed, the system may also include a mechanical disconnect feature in the rear steering assembly to facilitate towing operations when needed, which may bypass steering actuators at the rear of the vehicle while locking the front wheels in a forward or straight position. The rear steering assembly may include a pivot mechanism that facilitates the transition between powered operation with active steering and manual towing operations.

As indicated, the steering system may implement programmable Ackermann geometry, which dynamically calculates and controls individual wheel angles based on the vehicle's wheelbase and desired turning radius. This programmable approach can provide calculated wheel angles during turns that may reduce tire scrub and improve maneuverability. The system can operate in either incremental or absolute control modes, providing operators with flexible control options based on specific operational requirements. In some aspects, the Ackermann geometry calculations may be performed in accordance with the following equations for different steer modes:

### Front Wheel Steer

Inner wheel angle (θᵢ)=arctan(L/(R−W/2))
Outer wheel angle (θₒ)=arctan(L/(R+W/2))
where:
   L=wheelbase (distance between front and rear axles)
R=turning radius measured to the center of the vehicle
W=track width (distance between wheels)

### Rear Wheel Steer

The calculations for rear wheel steering follow similar principles but are typically reversed:
Inner wheel angle (θᵢ)=arctan(L/(R−W/2))
Outer wheel angle (θₒ)=arctan(L/(R+W/2))

The main difference is that the turning center is now projected forward of the vehicle rather than behind it.

### Coordinated Four Wheel Steer

In four-wheel steering mode, both front and rear wheels are coordinated:

### Front Wheels:

Inner front wheel=arctan(L/(R−W/2))
Outer front wheel=arctan(L/(R+W/2))

### Rear Wheels:

Inner rear wheel=−arctan(L/(R−W/2))
Outer rear wheel=−arctan(L/(R+W/2))

The negative angles for rear wheels indicate opposite steering direction from front wheels.

### Crab Steer

In crab steering, all wheels turn to the same angle (θ):
All wheels: θ=desired crab angle (typically 0° to 45°)

No Ackermann compensation is typically needed as all wheels follow parallel paths, and the turning radius becomes: R=L/sin(θ).

### Differential Steering

Differential steering uses wheel speed differences rather than geometric steering angles. For a given turning radius (R):
Outside wheel velocity (Vₒ)=ω(R+W/2)
Inside wheel velocity (Vᵢ)=ω(R−W/2)
Where:
ω=angular velocity of turn
For zero-radius turns (R=0), inside wheels rotate opposite to outside wheels

Additionally, steering may include one or more speed-dependent safety modifications. For example, at higher speeds, maximum turn angle or maximum turn rate could be limited to maintain dynamic stability of the vehicle. Additionally, dynamic compensation may be applied and may include, for example, load-dependent adjustments, surface condition compensation, and dynamic stability control. In some aspects, steering control may also account for one of more practical limitations, such as maximum wheel angles (e.g., ±45°), mechanical stops, actuator rates, structural clearances, or any combination thereof. In some aspects, a steering controller in a control system may perform various steering calculations, such as by using real-time calculations of required angles, monitoring actual versus commanded positions, implementing safety limits, providing fault detection, or any combination thereof. For example, each wheel may include an electronic control unit (ECU) that indicates individual wheel positions, and position feedback sensors for precise angle control.

In some aspects, the steering controller may continuously calculate a turn radius based on the active steering mode and current wheel angles. This real-time calculation can allow for precise maneuvering and permits the operator to select the vehicle's path based on environmental constraints and operational requirements. In some aspects, for the incremental steering mode, wheel angle adjustments can be made relative to the wheels' current positions, allowing for fine-tuned adjustments during operation, and in the absolute steering mode, wheel angles can be set relative to a fixed reference position, enabling precise positioning regardless of the previous wheel orientation. The control system architecture may include an operator interface that receives steering commands and provides them to a steering controller (e.g., one or more processors that perform steering control algorithms) that translates them into specific wheel angle setpoints. The steering controller can process these inputs according to the selected steering mode and generate appropriate commands for each steering actuator, ensuring coordinated movement of all wheels in accordance with the desired steering pattern.

Further, the steering controller may maintain specific geometric relationships between wheel angles in each steering mode through continuous monitoring and adjustment. These relationships may be predetermined based on the vehicle's mechanical constraints and operational requirements, ensuring enhanced maneuverability while preventing mechanical interference between components during steering operations. As shown in FIGS. 8-15, the operator interface 802 may provide for remote control or teleoperation of the lift truck, as opposed to traditional ride-on vehicle control such as used for control of vehicles like the MJ-1 and MHU-83. Such remote control or teleoperation may allow for more accurate control (e.g., by an operator located at a front of the vehicle while positioning the lift table to load munitions) by a single operator, rather than having multiple people involved in the positioning of the vehicle. Additionally, providing for control without a ride-on operator can allow a smaller form factor for the vehicle and efficient operation in relatively tight spaces or under aircraft or other equipment, while providing an operator with a better vantage point than traditional ride-on vehicles. Further, in some aspects, operation at the front of the vehicle using operator interface 802 may lock-out control or may lock-out specific control features of the vehicle from another interface (e.g., an interface located on a rear of the vehicle), thereby enhancing safety through reduction of potential inadvertent or erroneous movement commands from someone other than the operator that is positioning the lift table or other tool that may be mounted on the vehicle.

In some aspects, the operator interface 802 may provide for mode selection control, status display, error indication, and/or manual override controls. The operator interface 802 may interface with control systems of the vehicle (e.g., one or more steering controllers, one or more lift controllers, etc.) via a CAN bus. CAN architectures are known in the art, and provide a robust vehicle bus standard designed to allow microcontrollers and ECUs to communicate with each other without a host computer. The architecture operates on a multi-master system where any node can initiate message transmission based on priority, with higher priority messages taking precedence over lower priority ones through a non-destructive arbitration process. CAN bus uses differential signaling (CAN High and CAN Low) to provide noise immunity and fault tolerance, while its message-based protocol allows devices to communicate using short data frames that include message IDs, data fields, and error checking capabilities. In some aspects, the CAN bus architecture of a vehicle as discussed herein may connect various control modules and sensors in a daisy-chain configuration, with terminating resistors at each end of the bus to prevent signal reflection. Each node on the network can send and receive messages, but not simultaneously, and all nodes can receive every message broadcast on the bus regardless of whether they are the intended recipient. This allows for efficient system-wide data sharing and redundancy. The protocol supports real-time control with predictable latency and includes built-in error detection and fault confinement mechanisms, making it well-suited for critical vehicle control systems where reliability and deterministic behavior are essential.

In some aspects, the steering of the lift truck can be selectively configured for autonomous operation in an autonomous steering control mode. That is, the lift truck may be configured to perform certain maneuvers and/or functions in an autonomous sub-routine. For example and without limitation, the lift truck can be configured to autonomously position itself relative to a delivery system, such as an aircraft, for loading or unloading ordnance into or out of a delivery bay of the aircraft. In a particular aspect, the aircraft can be provided with a fixed fiducial marker that can be recognized by the steering system (such as by computer vision), and the lift truck can autonomously position itself at the optimal position relative to the fiducial marker for loading or unloading the ordnance into or from the delivery bay.

Moreover, in some aspects, the lift table 114 (shown in FIG. 1) and/or the lift arm 118 (shown in FIG. 1) may be autonomously operable in an autonomous control mode to allow for autonomous handling and/or loading/unloading of ordnance. Providing such selective autonomous control of the steering, handling, and/or loading systems may improve the precision and/or efficiency of those systems and/or may increase operator safety by allowing for remote, accurate operation during hazardous maneuvers and functions of the lift truck (such as loading heavy ordnance) or in hazardous external conditions (such as in a combat zone). In other aspects, any or all of the steering, handling, and/or loading systems of the lift truck can be fully autonomous.

In some aspects, the lift truck may be provided with 3D mapping, specifications, and/or other information related to the specific delivery system that the lift truck is servicing and/or the specific ordnance that the lift truck is handling to facilitate positioning, loading, unloading, and other operations.

In example aspects, the lift truck can further be equipped with one or more sensors for analyzing the readiness of the delivery system, e.g., the aircraft, for operation. For example and without limitation, the lift truck may be equipped with sensors configured to scan the aircraft and/or the delivery bay for defects and/or damage, to detect the fuel level of the aircraft, to discern whether ice is present on the wings of the aircraft, etc. In some aspects, one or more of the sensors can be a visual sensor, which can comprise a camera with automated processing capabilities for detecting, analyzing, and inspecting objects. The sensors may be configured to analyze the readiness of the aircraft before, during, or after loading/unloading the ordnance. In some aspects, the vehicle control system can communicate the sensors'findings to a readiness management system of the aircraft.

As discussed above, in some aspects, the described lift truck may include one or more power sources. FIGS. 16 through 19 show diagrams of example modular power sources of a lift truck (which may be similar to the lift truck 100 shown in FIGS. 1 and 1A) in accordance with various aspects of the present disclosure. As illustrated in FIGS. 16 through 19, a modular power source 112 may be coupled with the vehicle chassis 1702 at a latch point 1804 by a latch 1602, and may include a handle 1604 and wheels 1606. In some aspects, the latch 1602 may be disengaged from the latch point 1804 which may allow the modular power source 112 to rotate about a pivot point 1704 and allow wheels 1606 to contact the ground. The handle 1604 may be rotated into an up position and may be used to move the modular power source 112 to a different location. A replacement modular power source 112 may then be reconnected in a reverse matter, allowing an electrical interface 1802 to connect with a corresponding electrical interface 1902 of the lift truck and supply power.

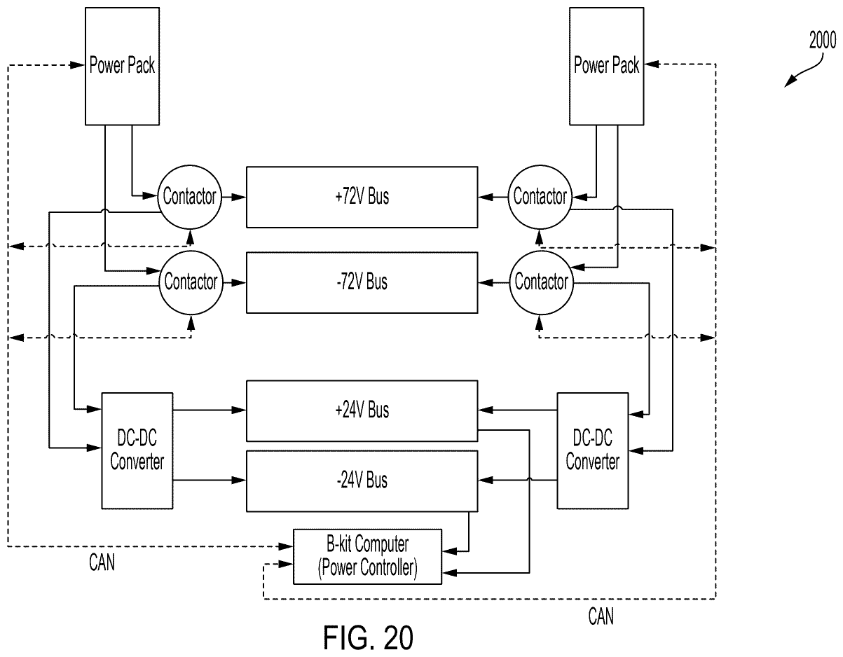

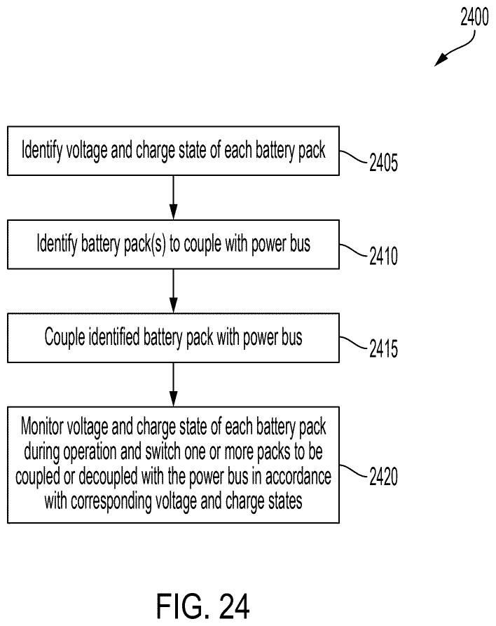

FIG. 20 shows an example power architecture 2000 of a lift truck (which may be similar to the lift truck 100 shown in FIGS. 1 and 1A) that may use modular power sources 112. In this example, multiple power packs may be connectable via contactors with different DC buses, including a 72 Volt buses and 24 Volt buses, where redundant DC-DC converters may convert a 72V output from power packs to 24V, providing failover of the control system bus. A vehicle controller (which may be referred to as a B-kit computer) may control operation of the system. In some examples, the power controller is configured to perform power management processes, such as managing the charging and discharging of the power packs, and connection of one or both power packs to one or more DC buses to support operation of the lift truck. An example of a power management process is described with reference to FIG. 24.

The power controller may include one or more chips, SoCs, chipsets, packages, components or devices that individually or collectively constitute or include a processing system. The processing system may interface with other components of the power system, and may generally process information (such as inputs or signals) received from such other components and output information (such as outputs or signals) to such other components. The vehicle controller may include one or more processors (such as central processing units (CPUs), graphics processing units (GPUs), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 4G, 5G or 6G compliant) modem). In some implementations, one or more processors of the processing system may include or implement one or more of the modems.

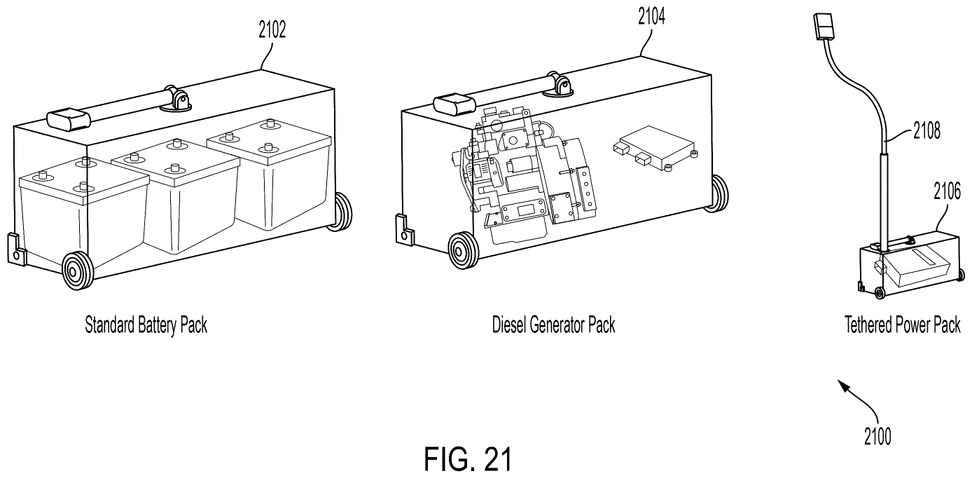

Referring again to modular power sources 112, in some aspects these components may provide a quick-attach/detach mechanism. In some aspects, such a mechanism may provide a single-hand operation latch mechanism 1602, a pivot mechanism for ground deployment, integrated transport wheels 1606, a deployable handle 1604, which may double as a tow bar, and automatic electrical connections. In some aspects, such as illustrated in FIGS. 21 through 23, a modular power source 112 may be an interchangeable battery pack (e.g., a battery pack 2102 as shown in FIG. 21), may include a generator module such as a jet fuel, diesel or gasoline powered motor/generator, an alternating current (AC) shore power module such as a pack that includes an interface to 120V, or 240V single-phase or three-phase shore power and an inverter to output direct current (DC) power (e.g., a tethered power pack 2106 with shore power connection 2108 as shown in FIG. 21).

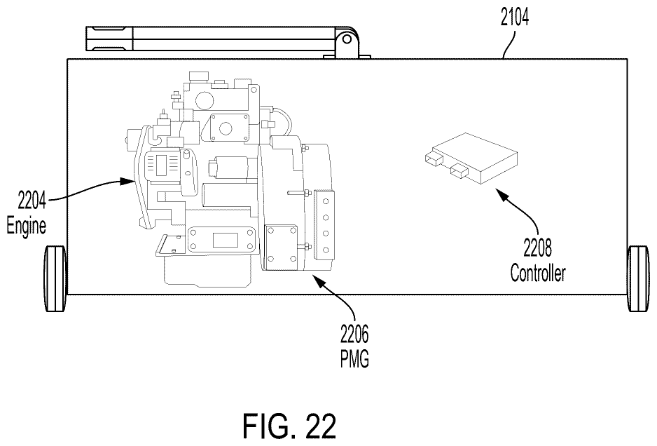

An example of a generator module is shown in FIG. 22, in which a diesel generator pack 2104 may include a diesel engine 2204, a permanent magnet generator (PMG) 2206, and a controller 2208 that provides a control interface with a power controller of the lift truck (which may be similar to the lift truck 100 shown in FIGS. 1 and 1A) and that controls operation of the diesel engine 2204 and PMG 2206.

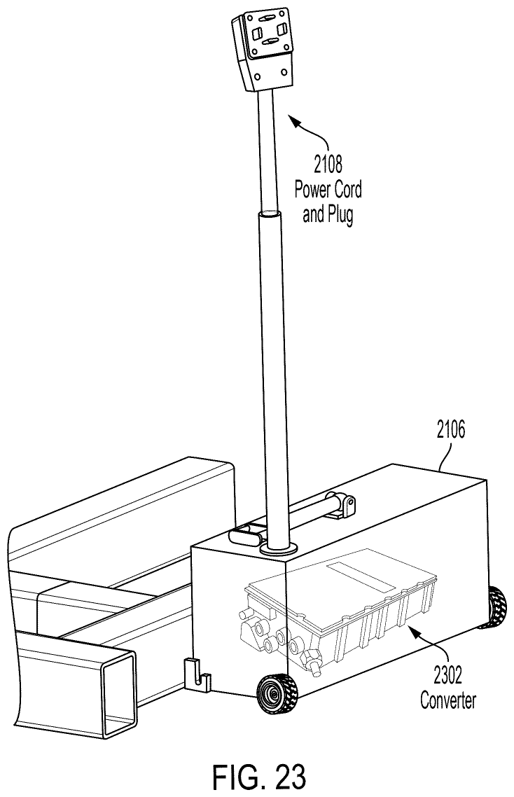

An example of a tethered power pack 2106 is shown in FIG. 23, in which a shore power connection 2108 may include a power cord and plug, and a converter 2302 may convert incoming AC power to DC power that can be supplied to the power system of the lift truck (which may be similar to the lift truck 100 shown in FIGS. 1 and 1A). The tethered power pack may also include a controller that can provide a control interface with a power controller of the lift truck and that can control operation of the converter 2302. The tethered power pack may provide an energy-efficient option for extended indoor operations or maintenance activities where continuous power is available. In each case, the different modular power sources 112 may have a common form factor and connection interface such that any type of power source may be coupled with the lift truck and provide power thereto.

In some aspects, the vehicle control system of the lift truck may recognize that a power source is present, and a type of power source. The controller of the vehicle control system (e.g., one or more processors that execute one or more power control algorithms) may provide automated power source management, including voltage/current monitoring of each power source, automatic switching between power sources, charge equalization control, CAN bus identification of power module type, or any combination thereof. Further, power sources may be hot-swappable, which may allow for continuous operation during power source changes, and automatic electrical connections in accordance with one or more power packs that may be present at any given time. In some aspects, a lift truck such as discussed herein may use a hot-swappable dual modular power source system that enables continuous operation during power source changes. Such a system may utilize two independent modular power sources, each providing the same nominal voltage to the vehicle's high-voltage bus. The vehicle's controller computer system (e.g., a “B-kit” computer) may actively monitor the voltage of each modular power source and determine when to connect each pack to the main bus using contactors. In some examples, only one battery pack may be required to power the bus, computers, drive system, and hydraulics, allowing the other pack to be removed and replaced while maintaining vehicle operation. When a new modular power source (e.g., a fresh battery pack) is installed while the vehicle is running on the other modular power source, the computer system can automatically read the voltage of the newly installed modular power source. The system can then perform a switch to couple a power bus of the vehicle with the modular power source with the higher state of charge. When charge states become equalized, the system may connect to both power sources, may alternate between power sources, or may use a power source that is selected by an operator (e.g., to use a generator power source in an outdoor environment in order to avoid depleting a battery pack power source, and to switch to the battery pack power source when moving into an indoor environment).

Additionally, in examples that use one battery pack power source and one generator power source, the battery pack may serve to absorb electrical shock loading and provide the amperage spikes that may occur during normal drive functions and hydraulic actuation, while the diesel genset may maintain the state of charge of the battery pack. The generator power source can be configured with various power plants including gasoline, diesel, hydrogen, natural gas, propane, or fuel cell options, and may incorporate a PMG with an integrated controller to manage engine speed, voltage, and current. In some aspects, the system may use CAN bus identification to automatically recognize which type of power module is connected.

In cases where two battery pack power sources are installed, the system may implement one or more power management features to handle the interaction between multiple battery packs. For example, when two battery pack power sources are installed, the vehicle controller system may only connect them to the DC power bus simultaneously when the voltage difference between the two packs is below a predetermined threshold. This prevents potentially damaging current inrush from a higher-charged pack to a lower-charged pack. Alternatively, the system may utilize an integrated charge equalizer circuit that gradually equalizes the charge between the two packs, eliminating the need for simultaneous source switching. The hot-swap capability can be further enhanced by the vehicle's quick-attach/detach mechanism, which can feature automatic electrical connections that engage and disengage as the battery pack is latched or unlatched from the vehicle. These connections can be self-guiding or spring-loaded to ensure proper alignment and conductivity, requiring no manual intervention from the operator to establish or break electrical connections. This automated connection system, combined with the intelligent power management features, can create a seamless battery exchange process that maintains continuous vehicle operation throughout the swap procedure.

As discussed, in some aspects the lift truck may include a control system. The control system may include one or multiple controllers, processors, or computers that provide power management capabilities, steering control functionality, and lift table operation functionality. As discussed, the power management aspect can monitor voltage levels across multiple power sources, automatically controlling contactors to connect and disconnect power sources based on their charge states. The steering control aspect can manage the multiple steering modes while supporting both incremental and absolute control methodologies. The control architecture can also incorporate programmable Ackermann steering calculations to optimize individual wheel angles based on vehicle geometry and desired turning radius. The overall control architecture can utilize CAN bus communication to coordinate between various system components. The CAN bus can enable identification of installed power module types and facilitate real-time communication between the vehicle's computer(s), steering actuators, hydraulic systems, lift systems, and power management systems. This integrated approach allows the control system to manage mode transitions, monitor system status, and maintain precise control over steering, power, and lift systems while providing necessary feedback to operators.

In some aspects, a modular power source may include multiple battery packs that are each self-contained battery packs that have an integrated charge controller system. The multiple battery packs may be connected in series to provide an operating voltage of the lift truck or other piece of equipment that may use an operating voltage that is higher than an output voltage of one of the battery packs. Interconnection of individual battery packs in such a manner may present multiple challenges. For example, voltage balancing among series-connected battery packs may be challenging because individual battery packs may charge and discharge at different rates, and the separate charge controllers may compete with each other trying to maintain their individual pack voltages. Further, voltage imbalances between packs can lead to circulating currents, and a series configuration may result in total voltage variations that may compound across packs, and individual pack protection circuits may trigger at different voltage thresholds. Additionally, individual packs may naturally develop voltage differences due to variations in internal resistance, temperature, age, and usage patterns. These differences are exacerbated by each pack's independent charge controller attempting to maintain its specific pack within predetermined voltage limits. Without proper coordination, these individual control actions can lead to competing behaviors where one controller's attempt to balance its pack creates imbalances in others.

In order to accommodate such series connections of packs, various aspects of the present disclosure may provide for coordination of the multiple charge controllers. For example, a main controller associated with a modular power source may communicate with each charge controller to obtain a corresponding state and status, and manage power control to avoid a risk of conflicting control decisions between controllers. In some cases, the main controller may implement active balancing strategies that consider the state of all packs simultaneously, rather than allowing each pack to operate independently. For example, the vehicle controller may deliberately limit the charge or discharge rates of certain packs to maintain overall system balance, or implementing cross-pack balancing circuits that can actively transfer energy between packs to maintain voltage equilibrium. In such cases, each individual pack charge controller may operate as a semi-autonomous unit with its own protection circuits, voltage monitoring, and control algorithms, and also respond to commands from the main controller. The main controller may manage conflicting priorities between individual pack controllers and system-level requirements. For example, one pack's controller might initiate a charging cycle based on its local conditions, while the main controller needs to prevent this action based on overall system state or operational requirements. In some cases, the main controller may implement an override protocol and arbitration mechanism to resolve conflicts while maintaining system stability.

FIG. 24 shows an example flow chart 2400 of operation for a battery pack that includes multiple battery modules in accordance with various aspects of the present disclosure. The operations of the flow chart 2400 may be implemented by a vehicle controller or its components as described herein. For example, the operations of the flow chart 2400 may be performed by a B-kit computer such as described with reference to FIG. 20.

In this example, at 2405, the power controller may identify a voltage and charge state for each battery pack. For example, a controller at a battery pack may provide information via a CAN bus that indicates the voltage and charge state. At 2410, the power controller may identify battery pack(s) to couple with the power bus. Such an identification may be performed in accordance with techniques discussed herein, such as based on a voltage level of each pack, a difference in pack voltage levels, and the like.

At 2415, the vehicle controller may couple the identified battery pack(s) with the power bus. In some aspects, the vehicle controller may control a contactor to couple the battery pack to the power bus, such as via a command sent using the CAN bus. At 2420, the vehicle controller may monitor a voltage and charge state of each battery pack during operation, and switch one or more packs to be coupled or decoupled with the power bus in accordance with corresponding voltage and charge states. Such monitoring and switching may be performed in accordance with techniques discussed herein. In some aspects the vehicle controller may provide a status update that may be provided to an operator or equipment manager that may be used in operational decisions related to the lift truck (which may be similar to the lift truck 100 shown in FIGS. 1 and 1A) or one or more other lift trucks or pieces of equipment associated with a mission or operation.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,”’ or the equivalent in context, whatever it is that is “based on ‘a,”’ or“ based at least in part on ‘a,”’ may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed, that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. An ordnance handling apparatus comprising:
a pair of front steering assemblies each coupled with a corresponding front wheel to provide independently steerable front wheels, wherein the pair of front steering assemblies and associated front wheels are mechanically separated to allow a lift table of the ordnance handling apparatus to be positioned between the pair of front steering assemblies at an elevation above or below a mid-point of the front steering assemblies;
a rear axle assembly having independently steerable rear wheels;
a plurality of steering actuators operatively connected to the front wheels and the rear wheels; and
a controller configured to selectively operate the ordnance handling apparatus in a selected steering mode of multiple selectable steering modes.

2. The apparatus of claim 1, wherein the multiple selectable steering modes include two or more of:
a front-wheel steering mode wherein only the front wheels are steered while the rear wheels remain fixed;
a rear-wheel steering mode wherein only the rear wheels are steered while the front wheels remain fixed;
a four-wheel steering mode wherein both front and rear wheels are steered in opposite directions to reduce a turning radius of the ordnance handling apparatus;
a crab steering mode wherein all wheels are steered in a same direction for lateral movement of the ordnance handling apparatus;
a differential steering mode wherein the wheels on one side of the ordnance handling apparatus rotate in a different direction than the wheels on an opposite side of the ordnance handling apparatus; or
a carousel steering mode wherein both the front wheels and the rear wheels are oriented about a turning point located on the longitudinal axis of the ordnance handling apparatus.

3. The apparatus of claim 2, wherein the multiple selectable steering modes further include autonomous steering mode wherein the ordnance handling apparatus is configured to autonomously steer itself to a desired position relative to a delivery system.

4. The apparatus of claim 1, wherein the controller is further configured to:
calculate and implement Ackermann steering angles for the front wheels during turning maneuvers; and
enable switching between incremental steering control and absolute steering control.

5. The apparatus of claim 1, wherein the controller is configured to calculate turn radius based on the selected steering mode and wheel angles.

6. The apparatus of claim 1, wherein the controller is configured to operate in:
an incremental steering control mode in which wheel angle adjustments are made relative to current wheel positions; and
an absolute steering control mode in which wheel angle adjustments are made relative to a fixed reference position.

7. The apparatus of claim 1, wherein the controller is configured to:
receive steering input commands from an operator interface;
determine wheel angle setpoints for each steerable wheel based on the selected steering mode; and
control one or more of the steering actuators to achieve the determined wheel angle setpoints.

8. The apparatus of claim 1, wherein the controller implements programmable Ackermann steering by:
calculating an inner wheel angle and an outer wheel angle for the front wheels based on vehicle geometry, desired turn radius, and steering mode; and
independently controlling the steering actuators connected to the front wheels to achieve the calculated inner wheel angles and the calculated outer wheel angles.

9. The apparatus of claim 1, wherein the controller is configured to implement programmable velocity-based traction control, wherein a centerline velocity of the ordnance handling apparatus remains constant when entering a turn by proportionally decreasing a velocity of the inside wheels and proportionally increasing a velocity of the outside wheels based the selected steering mode and calculated steering angles of the wheels.

10. The apparatus of claim 1, further comprising:
a lift arm coupled with a chassis of the ordnance handling apparatus that includes a quick change tool plate configured to engage with the lift table or one or more other tools.

11. The apparatus of claim 10, wherein:
the lift table is rotatable and tiltable relative to the quick change tool plate to provide for precise movement of an item located on the lift table.

12. The apparatus of claim 10, wherein:
the one or more other tools include one or more of fork attachment, auxiliary lifting or positioning mechanism, rotator, or any combination thereof.

13. The apparatus of claim 10, wherein:
the quick change tool plate includes one or more of a data port; and
one or more of the lift table or the one or more other tools include an identification module readable by the quick change tool plate, and wherein the quick change tool plate provides an indication of a tool identification to the controller via the data port.

14. The apparatus of claim 1, further comprising one or more sensors for analyzing the operational readiness of a delivery system, and wherein the one or more sensors comprise a visual sensor configured to detect at least one of defects and damage to the delivery system.

15. A modular power supply apparatus for a vehicle, the modular power supply apparatus comprising:
a vehicle chassis that includes an electrical system, a control system, and a propulsion system; and
two or more power supply packs mountable on the vehicle and configured to provide operating power to the electrical system, each power supply pack of the two or more power supply packs comprising:
a quick-latch mechanism configured to engage with a securement assembly on the vehicle chassis and couple a power port associated with the power supply pack with a corresponding vehicle power port that is connected to the electrical system; and
a transport mechanism configured to provide for movement of the power supply pack toward and away from the vehicle chassis,
wherein a first power supply pack is configured to be disengaged from the vehicle chassis and electrical system while a second power supply pack is providing operating power to the electrical system, and a third power supply pack is configured to be engaged with the vehicle chassis and electrical system while the second power supply pack is providing operating power to the electrical system, and the control system initiates use of operating power from the third power supply pack responsive to the third power supply pack being engaged with the electrical system.

16. The apparatus of claim 15, wherein:
the two or more power supply packs include one or more of a battery pack, an internal combustion engine-based generator pack, or a tethered power converter pack.

17. The apparatus of claim 16, wherein:
each of the battery pack, the internal combustion engine-based generator pack, and the tethered power converter pack have a same form factor for engagement with the quick-latch mechanism.

18. The apparatus of claim 15, wherein the quick-latch mechanism comprises:
a securement mechanism that mechanically couples each power supply pack with the vehicle chassis; and
an electrical disconnect mechanism that engages the power port of the power supply pack with the electrical system when the power supply pack is mechanically coupled with the vehicle chassis.

19. The apparatus of claim 15, wherein at least one of the power supply packs comprises:
a set of battery modules that each have an associated charge controller; and
a group controller coupled with each of the charge controllers of each battery module of the set of battery modules, wherein the group controller independently controls each of the charge controllers associated with the set of battery modules.

20. The apparatus of claim 19, wherein:
the group controller monitors a charge state and voltage level associated with each battery module of the set of battery modules, and couples different combinations of battery modules with a power bus to manage different charge and voltage levels associated with different battery modules.
